(19) United States
(12) Patent Application Publication
(10) Pub. No.: US 2005/0150922 A1
(43) Pub. Date: Jul. 14, 2005

(54) Grocery grabber

(76) Inventor: Noah Rendall Halpern, Newton, MA (US)

Correspondence Address: Noah Halpern, 90 Waban Pk, Newton, MA, 02458, US

(21) Appl. No.: 10/752,619

(22) Filed: Jan. 8, 2004

(51) Int. Cl. B60R 7/00; B60R 9/00; B60R 11/00

(52) U.S. Cl. 224/572

(57) ABSTRACT

The grocery grabber is completely revolutionary. Nothing even related has been invented or can be found in any cars.

### RELATED APPLICATIONS AND CROSS REFERENCES

None

### BACKGROUND

The field of this device is cars.

### DESCRIPTION

A grocery grabber is essentially a seatbelt for groceries. Located in the walls of the trunk the grocery grabber will keep grocery bags from falling. You can put the bag against the wall. Then you will pull the “belt” out of the wall around the bag and put it into the clip. The clip and the piece that it secures can be the same clip used for a seatbelt and the strap can be of the same material of a seatbelt or more preferably a more elastic type material. If not in use the grocery grabber will be in the wall and would not take any space away from the trunk. Car manufactures can make and install this device in there cars with almost no downside. The grocery grabber has no downside because of its inexpensiveness and its being so compact that if you didn't need it you would not know it was there.

1. I hereby claim that my patent device can be applied to all cars, furthermore, my patent provides worry free driving and safe groceries when in use, and can easily be kept in the wall when not required.
